(19) United States
(12) Patent Application Publication
(10) Pub. No.: US 2006/0033683 A1
(43) Pub. Date: Feb. 16, 2006

(54) Plasma display apparatus and driving method thereof

(76) Inventor: Jeong Pil Choi, Suwon-si (KR)

Correspondence Address: Song K. Jung;MCKENNA LONG & ALDRIDGE LLP, 1900 K Street, N.W., Washington, DC, 20006, US

(21) Appl. No.: 11/200,301

(22) Filed: Aug. 10, 2005

(30) Foreign Application Priority Data
Aug. 11, 2004 (KR) 10-2004-0063329

(51) Int. Cl. G09G 3/28

(52) U.S. Cl. 345/60

(57) ABSTRACT

A plasma display apparatus and a driving method thereof are provided. The apparatus includes: a plasma display panel for displaying an image; and a scan driver and a sustain driver each having an energy recovery circuit, and driving the plasma display panel, wherein the plasma display panel is divided into a plurality of image regions, and the energy recovery circuit is provided in number as many as the plurality of image regions of the plasma display panel to supply a separate sustain driving pulse to each screen block.

This Nonprovisional application claims priority under 35 U.S.C. § 119(a) on Patent Application No. 10-2004-0063329 filed in Korea on Aug. 11, 2004, the entire contents of which are hereby incorporated by reference.

### BACKGROUND OF THE INVENTION

1. Field of the Invention

The present invention relates to a plasma display apparatus and a driving method thereof.

2. Description of the Background Art

In general, a plasma display panel (Hereinafter, referred to as “PDP”) displays an image including a character or a graphic by exciting a phosphor using ultraviolet ray of 147 nm, which is generated when an inert mixture gas of He+Xe or Ne+Xe is discharged.

FIG. 1 illustrates a conventional three-electrode alternating current surface discharge type PDP.

Referring to FIG. 1, the three-electrode alternating current surface discharge type PDP includes a scan/sustain electrode 11 and a sustain electrode 12 formed on an upper substrate 10, and an address electrode 22 formed on a lower substrate 20. The scan/sustain electrode 11 and the common sustain electrode 12 are respectively formed using transparent electrodes 11a and 12a, for example, of Indium-Tin-Oxide (ITO). Metal bus electrodes 11b and 12b are formed at each of the scan/sustain electrode 11 and the common sustain electrode 12 to reduce resistance. An upper dielectric layer 13a and a protective film 14 are layered on the upper substrate 10 having the scan/sustain electrode 11 and the common sustain electrode 12 formed thereon. Wall charges are generated in plasma discharge and accumulated on the upper dielectric layer 13a. The protective film 14 prevents the upper dielectric layer 13a from being damaged by sputtering generated in the plasma discharge, and increases a secondary electron emission efficiency. In general, the protective film 14 is formed of magnesium oxide (MgO).

A lower dielectric layer 13b and a barrier rib 21 are formed on the lower substrate 20 having the address electrode 22 formed thereon. A phosphor layer 23 is coated on surfaces of the lower dielectric layer 13b and the barrier rib 21. The address electrode 22 is formed in a direction of intersecting with the scan/sustain electrode 11 and the common sustain electrode 12. The barrier rib 21 is formed in parallel with the address electrode 22, thereby preventing ultraviolet rays and visible rays, which are generated in the plasma discharge, from being leaked to an adjacent discharge cell. The phosphor layer 23 is excited by the ultraviolet ray to generate any one of red, green and blue visible light. The inert mixture gas for discharge, such as He+Xe or Ne+Xe, is injected into a discharge space of the discharge cell. The discharge space is provided between the upper and lower substrates 10 and 20 and the barrier rib 21. A driving device of the conventional above-constructed PDP will be described with reference to FIG. 2.

FIG. 2 illustrates the conventional driving device of the alternating current surface discharge type PDP.

Referring to FIG. 2, the conventional driving device includes the PDP 100 arranged in a matrix such that the m×n number of discharge cells 1 are connected with scan/sustain electrode lines (Y1 to Ym), common sustain electrode lines (Z1 to Zm), and address electrode lines (X1 to Xn); a scan/sustain driver 102 for driving the scan/sustain electrode lines (Y1 to Ym); a common sustain driver 104 for driving the common sustain electrode lines (Z1 to Zm); and a data driver 106 for driving the address electrode lines (X1 to Xn). The scan/sustain driver 102 sequentially supplies a scan pulse and a sustain pulse to the scan/sustain electrode lines (Y1 to Ym) to sequentially scan the discharge cells 1 on a per-line basis and concurrently, to sustain a discharge at each of the m×n number of discharge cells 1. The common sustain driver 104 supplies the sustain pulse to all of the common sustain electrode lines (Z1 to Zm). The address driver 106 supplies image data to the address electrode lines (X1 to Xn) so that the image data is synchronized to the scan pulse.

The alternating current surface discharge type PDP driven as described above requires a high voltage of more than hundreds of voltages for the sustain discharge. Accordingly, to minimize the driving power necessary for the sustain discharge, energy recovery circuits are added to the scan/sustain driver 102 and the common sustain driver 104. The energy recovery circuit recovers a charged voltage from the scan/sustain electrode line (Y) and the common sustain electrode line (Z), and reuses the recovered voltage as a driving voltage in a next discharge.

FIG. 3 illustrates a conventional energy recovery circuit installed to recover the sustain discharge voltage.

Referring to FIG. 3, the conventional energy recovery circuit includes an energy supply/recovery unit 108, and a sustain voltage source unit 110. The energy supply/recovery unit 108 includes an inductor (L) connected between a panel capacitor (Cp) and a source capacitor (Cs); and first and second switches (S1 and S2) connected in parallel between the source capacitor (Cs) and the inductor (L). The first and second switches respectively include first and second diodes at their terminals. The sustain voltage source unit 110 is comprised of third and fourth switches (S3 and S4) connected in parallel between the panel capacitor (Cp) and the inductor (L). The panel capacitor (Cp) equivalently represents a capacitance formed between the scan/sustain electrode line (Y) and the common sustain electrode line (Z). The third switch (S3) is connected to a sustain voltage source (Vsus), and the fourth switch (S4) is connected to a ground voltage source (GND). The source capacitor (Cs) recovers a charge voltage from the panel capacitor (Cp) and is charged with the recovered voltage in the sustain discharge and concurrently, again supplies its charged voltage to the panel capacitor (Cp). The source capacitor (Cs) has a large capacitance, and is charged with a voltage of Vsus/2 corresponding half of the sustain voltage (Vsus). The inductor (L) forms a resonance circuit together with the panel capacitor (Cp). The first to fourth switches (S1 to S4) control a current flow. The energy recovery circuit installed at the common sustain driver 104 is disposed to be symmetric with the scan/sustain driver 102 centering on the panel capacitor (Cp).

In a conventional actual construction of the energy recovery circuit installed to recover the sustain discharge voltage, the sustain voltage source unit 110 is comprised of a plurality of switching elements, not only the third and fourth switches (S3 and S4), connected in parallel between the panel capacitor (Cp) and the inductor (L) as shown in FIG. 4.

FIG. 4 illustrates a conventional actual energy recovery circuit installed to recover the sustain discharge voltage, and FIG. 5 illustrates a parallel connection construction of the switching element in the energy recovery circuit of FIG. 4.

Referring to FIGS. 4 and 5, in the actual energy recovery circuit, the sustain voltage source unit 110 includes a plurality of switching elements for supplying a sufficient current, thereby generating the sustain discharge. The plurality of switching elements (S31, . . . ,S3n, S41, . . . ,S4n) have small current capacities, and are connected in parallel between the panel capacitor (Cp) and the inductor (L). The plurality of switching elements (S31, . . . ,S3n, S41, . . . ,S4n) having the small current capacities can more reduce a resistance than a single switching element having a large current capacity and also, are greatly advantageous in heat emission owing to the increasing number of components.

In a detailed description of the sustain voltage source unit 110 included in the actual energy recovery circuit, an output node (n) of the plurality of switching elements is commonly connected toward the panel. In other words, the sustain voltage (Vs) supplied to the whole panel is commonly supplied at one node of a circuit part.

As such, if the plurality of switching elements (S31, . . . ,S3n, S41, . . . ,S4n) is connected in parallel between the inductor (L) and the panel capacitor (Cp), thereby forming a common connection at the output node (n), it is theoretically expected that the same function would be shown in the same condition, but not in actual fact. This is because, even though the switching elements are of the same kind, each component of the switching elements is operated with a different performance due to various component deviations and a difference of driving characteristics.

As the size of the PDP becomes larger, the power switching elements should be proportionally increased in number and therefore, as a parallel-constructed component is increased in number, even the slightest component error is accumulated and resultantly, there occurs a drawback of partiality of heat emission to the component, increase of power consumption, and component damage.

### SUMMARY OF THE INVENTION

Accordingly, an object of the present invention is to solve at least the problems and disadvantages of the background art.

An object of the present invention is to provide a plasma display apparatus and a driving method thereof for, when a plasma display panel is driven, improving a disparity of current and heat emission characteristics, which is caused by a component deviation and a difference of driving characteristics of a switching element.

To achieve these and other advantages and in accordance with the purpose of the present invention, as embodied and broadly described, there is provided a plasma display apparatus including: a plasma display panel for displaying an image; and a scan driver and a sustain driver each having an energy recovery circuit, and driving the plasma display panel, wherein the plasma display panel is divided into a plurality of image regions, and the energy recovery circuit is provided in number as many as the plurality of image regions of the plasma display panel to supply a separate sustain driving pulse to each screen block.

In another aspect of the present invention, there is provided a driving method of a plasma display panel for displaying an image, wherein the plasma display panel is divided into a plurality of image regions, and a separate sustain driving pulse is supplied to each of the plurality of image regions.

The present invention has an effect in that when the sustain pulse is supplied from the energy recovery circuit, it is not supplied through one common output node, thereby, when a plasma display panel is driven, improving a disparity of current and heat emission characteristics, which is caused by a component deviation and a difference of driving characteristics of a switching element.

### BRIEF DESCRIPTION OF THE DRAWINGS

The invention will be described in detail with reference to the following drawings in which like numerals refer to like elements.

FIG. 1 is a perspective view illustrating a construction of a conventional three-electrode alternating current surface discharge type plasma display panel;

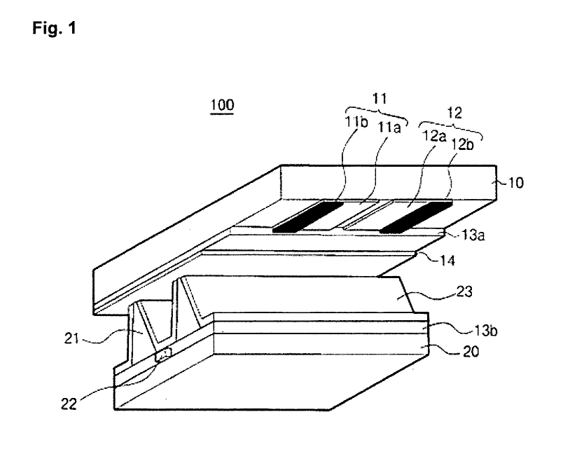

FIG. 2 illustrates a conventional driving device of a alternating current surface discharge type plasma display panel;

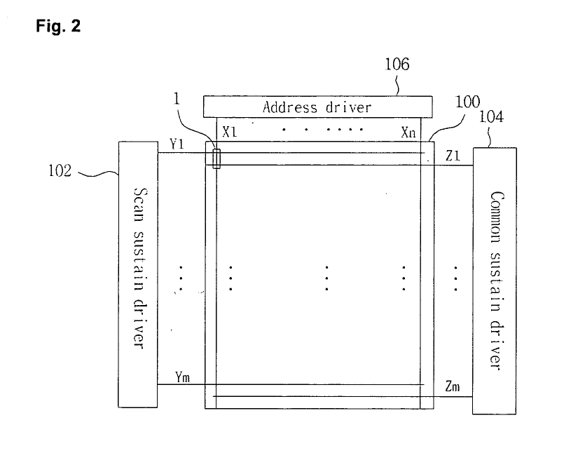

FIG. 3 illustrates a conventional energy recovery circuit installed to recover a sustain discharge voltage;

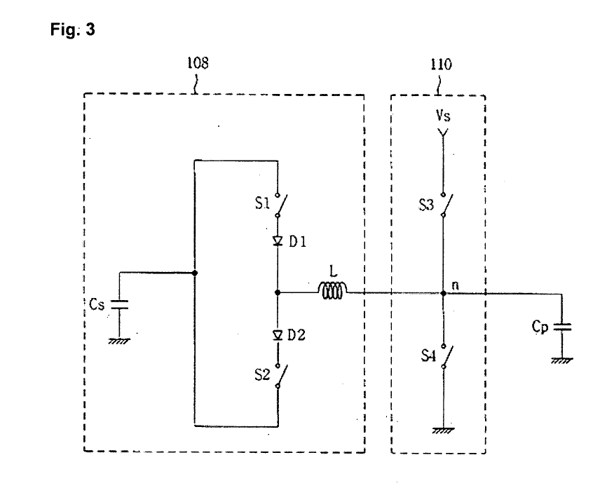

FIG. 4 illustrates a conventional actual energy recovery circuit installed to recover a sustain discharge voltage;

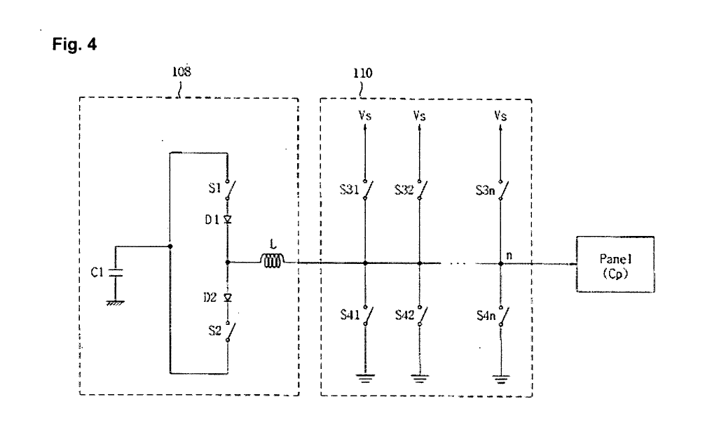

FIG. 5 illustrates a parallel connection structure of a switching element in the energy recovery circuit of FIG. 4;

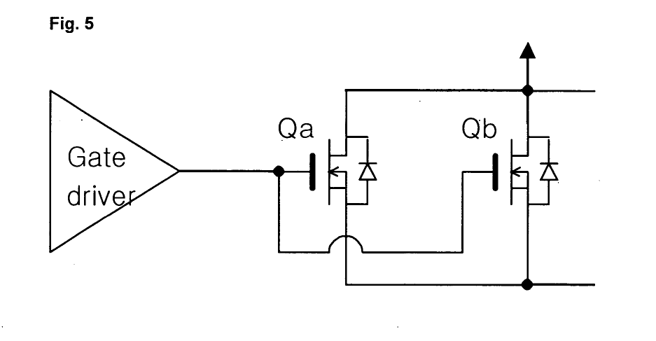

FIG. 6 illustrates a plasma display apparatus according to the present invention;

FIG. 7 illustrates an energy recovery circuit respectively included in a scan driver and a sustain driver according to the first embodiment of the present invention; and

FIG. 8 illustrates an energy recovery circuit respectively included in a scan driver and a sustain driver according to the second embodiment of the present invention.

### DETAILED DESCRIPTION OF PREFERRED EMBODIMENTS

Preferred embodiments of the present invention will be described in a more detailed manner with reference to the drawings.

A plasma display apparatus according to the present invention includes a plasma display panel for displaying an image; and a scan driver and a sustain driver each having an energy recovery circuit, and driving the plasma display panel, wherein the plasma display panel is divided into a plurality of image regions, and the energy recovery circuit is provided in number as many as the plurality of image regions of the plasma display panel to supply a separate sustain driving pulse to each screen block.

The plurality of image regions is two in number.

The energy recovery circuit includes an energy supply/recovery unit for supplying and recovering energy to and from the plasma display panel; and a sustain voltage source unit having a sustain voltage source and third and fourth switch groups to have a sustain voltage and a ground level at the plasma display panel.

The third and fourth switch groups are connected in parallel between the plasma display panel and the energy supply/recovery unit.

The energy supply/recovery unit includes an inductor for supplying and recovering energy stored in a voltage source, to and from the plasma display panel through resonance; and first and second switch groups for performing switching operations to enable the energy to be supplied to and recovered from the plasma display panel through the inductor.

The first and second switch groups are connected in parallel between the voltage source and the inductor.

A driving device of a plasma display panel according to the present invention, includes a scan driver and a sustain driver each having an energy recovery circuit, and driving the plasma display panel, wherein the plasma display panel is divided into a plurality of image regions, and the energy recovery circuit is provided in number as many as the plurality of image regions of the plasma display panel to supply a separate sustain driving pulse to each screen block.

A driving method of a plasma display panel for displaying an image, the plasma display panel is divided into a plurality of image regions, and a separate sustain driving pulse is supplied to each of the plurality of image regions.

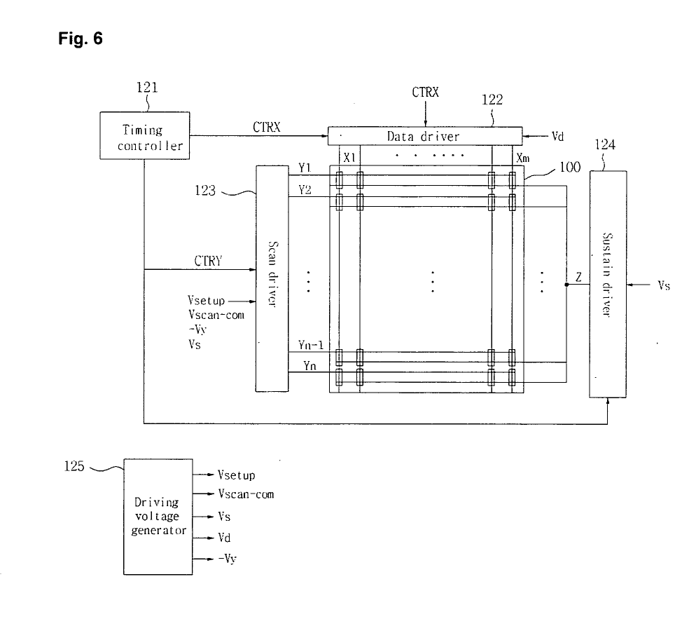

FIG. 6 illustrates a plasma display apparatus according to the present invention.

Referring to FIG. 6, the inventive plasma display apparatus includes a plasma display panel 100; a data driver 122 for supplying data to address electrodes (X1 to Xm) formed at a lower substrate (not shown) of the plasma display panel 100; a scan driver 123 for driving scan electrodes (Y1 to Yn); a sustain driver 124 for driving sustain electrodes (Z) being common electrodes; a timing controller 121 for controlling the data driver 122, the scan driver 123, and the sustain driver 124 when the plasma display panel 100 is driven; and a driving voltage generator 125 for supplying each of the drivers 122, 123 and 124 with a necessary driving voltage.

The plasma display panel 100 includes an upper substrate (not shown), and the lower substrate (not shown) spaced apart from and attached to the upper substrate. The upper substrate includes a plurality of electrodes, for example, the scan electrodes (Y1 to Yn) and the sustain electrode (Z) paired with each other. The lower substrate includes the address electrodes (X1 to Xm) intersected with the scan electrodes (Y1 to Yn) and the sustain electrode (Z).

The data driver 122 receives data, which is inverse gamma corrected and error diffused in an inverse gamma correction circuit and an error diffusion circuit and then mapped to each subfield in a subfield mapping circuit. The data driver 122 samples and latches the received data in response to a timing control signal (CTRX) of the timing controller 121 and then, supplies the latched data to the address electrodes (X1 to Xm).

The scan driver 123 supplies a ramp-up waveform and a ramp-down waveform to the scan electrodes (Y1 to Yn) in a reset period under the control of the timing controller 121. Further, the scan driver 123 sequentially supplies a scan pulse (Sp) of a scan voltage (−Vy) to the scan electrodes (Y1 to Yn) in an address period under the control of the timing controller 121. The scan driver 123 includes an energy recovery circuit (not shown) to supply a sustain pulse rising up to a sustain voltage, to the scan electrodes (Y1 to Yn) in a sustain period.

The sustain driver 124 includes an energy recovery circuit (not shown) like the scan driver 123 to supply the sustain pulse to the sustain electrodes (Z) in the sustain period under the control of the timing controller 121. The energy recovery circuit of the sustain driver 124 has the same structure as that of the scan electrode driver 123, and operates in an alternating manner with the energy recovery circuit of the scan electrode driver 123.

The timing controller 121 receives vertical and horizontal synchronous signals and a clock signal, and generates timing control signals (CTRX, CTRY and CTRZ) for controlling operation timing and synchronization of each of the drivers 122, 123 and 124 and a sustain pulse controller, and supplies the timing control signals (CTRX, CTRY and CTRZ) to the corresponding drivers 122, 123 and 124, thereby controlling each of the drivers 122, 123 and 124.

The data control signal (CTRX) includes a sampling clock for sampling the data, a latch control signal, and a switch control signal for controlling an on/off time of the energy recovery circuit and a driving switching element. The scan control signal (CTRY) includes a switch control signal for controlling an on/off time of a driving switching element and an energy recovery circuit installed in the scan driver 123. The sustain control signal (CTRZ) includes a switch control signal for controlling an on/off time of a driving switching element and an energy recovery circuit installed in the sustain driver 124.

The driving voltage generator 125 generates a setup voltage (Vsetup), a scan common voltage (Vscan-com), the scan voltage (−Vy), the sustain voltage (Vs), a data voltage (Vd) and the like. These driving voltages can be varied depending on a composition of a discharge gas or a structure of a discharge cell.

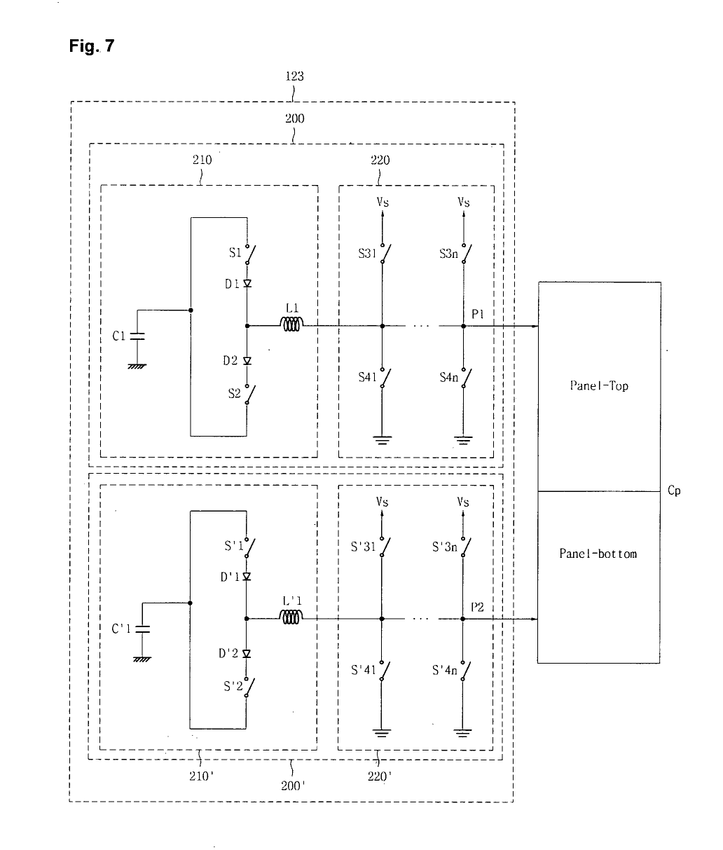

FIG. 7 illustrates the energy recovery circuit included both the scan driver and the sustain driver according to the first embodiment of the present invention.

FIG. 7 illustrates only the energy recovery circuit included in the scan driver 123, but the sustain driver (not shown) also includes an energy recovery circuit having the same construction and operation.

As shown in FIG. 7, the inventive scan driver 123 includes a first energy recovery circuit 200 and a second energy recovery circuit 200′. The first and second energy recovery circuits 200 and 200′ supply the sustain pulses to the plasma display panel in the sustain discharge. The sustain pulses supplied by the first and second energy recovery circuits 200 and 200′ are supplied to each region of a panel-top and a panel-bottom into which the plasma display panel is sectioned. In other words, the first and second energy recovery circuits 200 and 200′ supply the sustain pulses to the sectioned plasma display panel regions, independently.

The inventive plasma display panel is divided into two upper and lower image regions, but can be divided into a plurality of three or more image regions. The scan driver and the sustain driver include the energy recovery circuits as many as the plurality of image regions, to supply the sustain pulses to the plasma display panel.

The first and second energy recovery circuits 200 and 200′ respectively include energy supply/recovery units 210 and 210′, and sustain voltage source units 220 and 220′.

The energy supply/recovery unit 210 of the first energy recovery circuit 200 includes an inductor (L1) connected between a panel capacitor (Cp) corresponding to the plasma display panel and a source capacitor (C1) being a voltage source; and first and second switches (S1 and S2) and first and second diodes (D1 and D2) respectively connected in parallel between the source capacitor (C1) and the inductor (L1). The first switch (S1) and the first diode (D1), and the second switch (S2) and the second diode (D2) are connected in series, respectively. The source capacitor (C1) has a capacitance being capable of being charged with a voltage of Vs/2 corresponding to a half of the sustain voltage (Vs). The source capacitor (C1) recovers a charge voltage from each region of the panel capacitor (Cp) and is charged with the recovered voltage in a sustain discharge and concurrently, again supplies its charged voltage to each region of the panel capacitor (Cp). The inductor (L1) forms a resonance circuit together with the panel capacitor (Cp).

The sustain voltage source unit 220 of the first energy recovery circuit 200 includes a sustain voltage source (Vs), a third switch group (S31, S32, . . . ,S3n), and a fourth switch group (S41, S42, . . . ,S4n). The third switch group (S31, S32, . . . ,S3n) and the fourth switch group (S41, S42, . . . ,S4n) are connected in parallel between the panel capacitor (Cp) and the inductor (L1). Further, the third switch group (S31, S32, . . . ,S3n) is connected to the sustain voltage source (Vs), and the fourth switch group (S41, S42, . . . , S4n) is connected to a ground voltage source (GND).

The energy supply/recovery unit 210′ and the sustain voltage source unit 220′ of the second energy recovery circuit 200′ also have the same constructions as the energy supply/recovery unit 210 and the sustain voltage source unit 220 of the first energy recovery circuit 200.

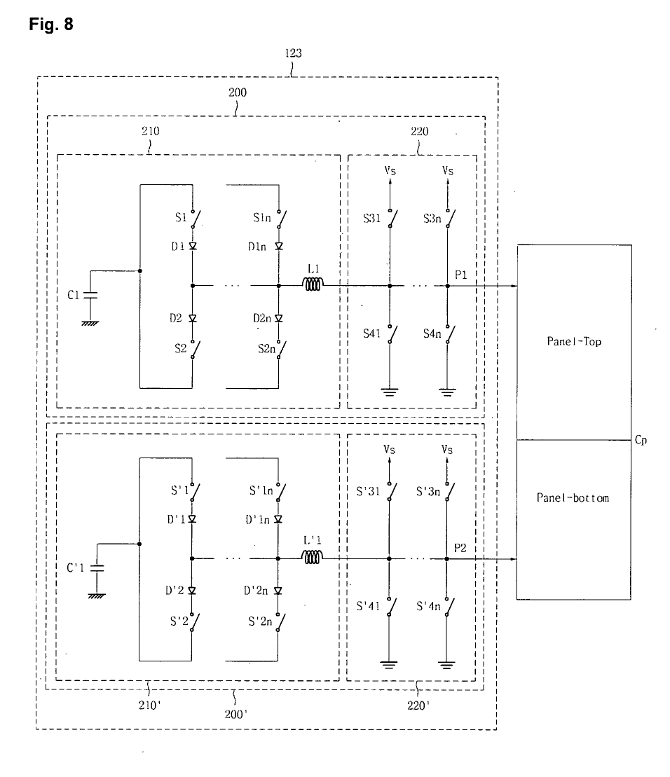

FIG. 8 illustrates an energy recovery circuit respectively included in a scan driver and a sustain driver according to the second embodiment of the present invention.

Referring to FIG. 8, the inventive energy recovery circuit has the same construction as the aforementioned energy recovery circuit according to the first embodiment of the present invention.

However, energy supply/recovery units 210 and 210′ of first and second energy recovery circuits 200 and 200′ include inductors (L1 and L1′); and a first switch group (S1, . . . ,S1n, S′1, . . . ,S′1n) and a second switch group (S2, . . . ,S2n, S′2, . . . ,S′2n), respectively. The inductors (L1 and L′1) enable energy stored in the voltage sources (C1 and C′1), to be respectively supplied to and recovered from the regions of the panel capacitor (Cp) corresponding to the plasma display panel, using resonance. The first switch group (S1, . . . ,S1n, S′1, . . . ,S′1n) and the second switch group (S2, . . . ,S2n, S′2, . . . ,S′2n) perform switching operations so that the energies are supplied to and recovered from the regions of the panel capacitor (Cp) through the inductors (L1 and L′1). The first switch group (S1, . . . , S1n, S′1, . . . ,S′1n) and the second switch group (S2, . . . ,S2n, S′2, . . . ,S′2n) are connected in parallel between the voltage sources (C1 and C′1) and the inductors (L1 and L′1).

The plasma display apparatuses according to the first and second embodiments of the present invention can supply the sustain pulse to each region of the panel capacitor (Cp) corresponding to the plasma display panel through the first and second energy recovery circuits of each of the scan driver and the sustain driver during the sustain discharge. Thus, a conventional driving characteristic, such as a component deviation and unbalanced current supply of a switching element, which occurs when a sustain pulse is supplied to a whole panel capacitor through one energy recovery circuit, can be minimized.

In the inventive driving device of the plasma display panel, since the output nodes P1 and P2 of the sustain pulses toward the panel capacitor are not commonly connected, a phase difference of current can be different, but since the sustain pulse is supplied to a separate panel capacitor region through each of the output nodes P1 and P2, an offset phenomenon resulting from the phase difference of current does not occur.

The inventive plasma display apparatus supplies the sustain pulse to the panel capacitor corresponding to the plasma display panel, through its divided first and second recovery circuits, that is, through the two output nodes, but two or more output nodes can be formed to supply the sustain pulses to the panel capacitor.

The invention above described may be varied in many ways. Such variations are not to be regarded as a departure from the spirit and scope of the invention, and all such modifications as would be obvious to one skilled in the art are intended to be included within the scope of the following claims.

What is claimed is:

1. A plasma display apparatus comprising:
a plasma display panel for displaying an image; and
a scan driver and a sustain driver each having an energy recovery circuit, and driving the plasma display panel,
wherein the plasma display panel is divided into a plurality of image regions, and the energy recovery circuit is provided in number as many as the plurality of image regions of the plasma display panel to supply a separate sustain driving pulse to each screen block.

2. The apparatus of claim 1, wherein the plurality of image regions is two in number.

3. The apparatus of claim 1, wherein the energy recovery circuit comprises:
an energy supply/recovery unit for supplying and recovering energy to and from the plasma display panel; and
a sustain voltage source unit having a sustain voltage source and third and fourth switch groups to have a sustain voltage and a ground level at the plasma display panel.

4. The apparatus of claim 3, wherein the third and fourth switch groups are connected in parallel between the plasma display panel and the energy supply/recovery unit.

5. The apparatus of claim 3, wherein the energy supply/recovery unit comprises:
an inductor for supplying and recovering energy stored in a voltage source, to and from the plasma display panel through resonance; and
first and second switch groups for performing switching operations to enable the energy to be supplied to and recovered from the plasma display panel through the inductor.

6. The apparatus of claim 5, wherein the first and second switch groups are connected in parallel between the voltage source and the inductor.

7. A driving device of a plasma display panel for displaying an image, the device comprising:
a scan driver and a sustain driver each having an energy recovery circuit, and driving the plasma display panel,
wherein the plasma display panel is divided into a plurality of image regions, and the energy recovery circuit is provided in number as many as the plurality of image regions of the plasma display panel to supply a separate sustain driving pulse to each screen block.

8. The device of claim 7, wherein the plurality of image regions is two in number.

9. The device of claim 7, wherein the energy recovery circuit comprises:
an energy supply/recovery unit for supplying and recovering energy to and from the plasma display panel; and
a sustain voltage source unit having a sustain voltage source and third and fourth switch groups to have a sustain voltage and a ground level at the plasma display panel.

10. The device of claim 9, wherein the third and fourth switch groups are connected in parallel between the plasma display panel and the energy supply/recovery unit.

11. The device of claim 9, wherein the energy supply/recovery unit comprises:
an inductor for supplying and recovering energy stored in a voltage source, to and from the plasma display panel through resonance; and
first and second switch groups for performing switching operations to enable the energy to be supplied to and recovered from the plasma display panel through the inductor.

12. The device of claim 11, wherein the first and second switch groups are connected in parallel between the voltage source and the inductor.

13. A driving method of a plasma display panel for displaying an image, wherein the plasma display panel is divided into a plurality of image regions, and a separate sustain driving pulse is supplied to each of the plurality of image regions.
